(19) United States
(12) Patent Application Publication
(10) Pub. No.: US 2008/0254412 A1
(43) Pub. Date: Oct. 16, 2008

(54) Gingivaformer

(75) Inventors: Sybille Korrodi, Kussnacht (CH); Fabian Schwieder, Basel (CH)

Correspondence Address: DYKEMA GOSSETT PLLC, 10 S. WACKER DR., STE. 2300, CHICAGO, IL, 60606, US

(73) Assignee: Straumann Holding AG, Basel (CH)

(21) Appl. No.: 12/103,121

(22) Filed: Apr. 15, 2008

(30) Foreign Application Priority Data
Apr. 16, 2007 (DE) 202007005474.2

(51) Int. Cl. A61C 8/00

(52) U.S. Cl. 433/174; 433/201.1

(57) ABSTRACT

A gingivaformer for a dental implant, wherein the gingivaformer is manufactured from a mixture of PEEK base material with a fraction of 95 to 99% by weight and at least one dye with a fraction of 1 to 5% by weight, so that the gingivaformer is flesh-colored.

The present invention relates to a gingivaformer for use with an implant, in particular for dental implants, which provides a natural looking appearance and further can be manufactured in a simple and cost-effectively manner.

### BACKGROUND OF THE INVENTION

In tooth implantation, for healing-in, an element is fastened on a dental implant inserted in the jaw. This element remains on the dental implant for the duration of the healing process in order, in this manner, on the one hand to guarantee full healing-in of the dental implant, i.e. the surface of the dental implant has an opportunity to grow into the jaw bone, and on the other hand to avoid the danger of infections. Due to such shielding of the oral cavity, undesired foreign bodies such as food remnants and/or pathogens cannot reach the implant site, which is to heal. Thus, neither can the interior of the dental implant be contaminated, which, due to the foreign bodies located therein, can impede the insertion of a tooth model, e.g. a crown, which is to be attached after the healing-in phase, nor can foreign bodies accumulate on the implant and thus give rise to possible infections. The healing-in phase lasts, in general, a few weeks to six months, before the tooth model produced by the dental technician can be finally attached. Due to the acidic environment in the oral cavity, which is caused by the saliva, and due to the chewing forces occurring in the oral cavity, the materials used for the manufacture of the gingivaformer must be very durable. A known starting or base material is so-called “medical grade” PEEK (polyetheretherketone), the expression “medical grade” meaning use in the medical field, which, because of its strength, resistance to organic and inorganic chemicals, and its biocompatibility, is particularly suitable for manufacture of gingivaformers. Gingivaformers are sufficiently known in several designs, materials and colors; thus e.g. designs made of plastics in black, white and natural-colored (greyish) are available. Such a selection of colors is not matched to the environment in the oral cavity and therefore does not satisfy any aesthetic aspects. Directly visible foreign bodies in the oral cavity are often viewed negatively or looked upon with amusement or pity; consider e.g. the known dental braces.

### SUMMARY OF THE INVENTION

The aim of the invention is creating a gingivaformer for a dental implant, which avoids the problems cited above.

Within this aim, a particular object of the present invention is to create an aesthetically appealing gingivaformer for a dental implant, which at the same time exhibits very good chemical and mechanical durability.

Further, the gingivaformer is to be suitable for adapting itself to the gingival environment in a “mimicry fashion”.

In addition, the gingivaformer is to be individually adaptable.

Moreover, a particular object of the present invention is to provide a gingivaformer for a dental implant, which can be manufactured easily and cost-effectively.

This aim and these and other objects, which will become better apparent hereinafter, are achieved by a gingivaformer according to appended claim 1. Advantageous further developments of the present invention are the subject of the subclaims.

### BRIEF DESCRIPTION OF THE DRAWINGS

Further features and advantages of the present invention and the manner of action of the exemplary embodiment of the present invention are described below with reference to the accompanying drawings. The accompanying drawings illustrate the present invention and further serve together with the description to explain the basic principles of the invention and to enable a person skilled in the art to manufacture and use the invention.

FIG. 1 is a perspective view of a gingivaformer according to an embodiment of the invention; and

FIG. 2 is a cross-sectional view of the gingivaformer.

### DESCRIPTION OF THE PREFERRED EMBODIMENTS

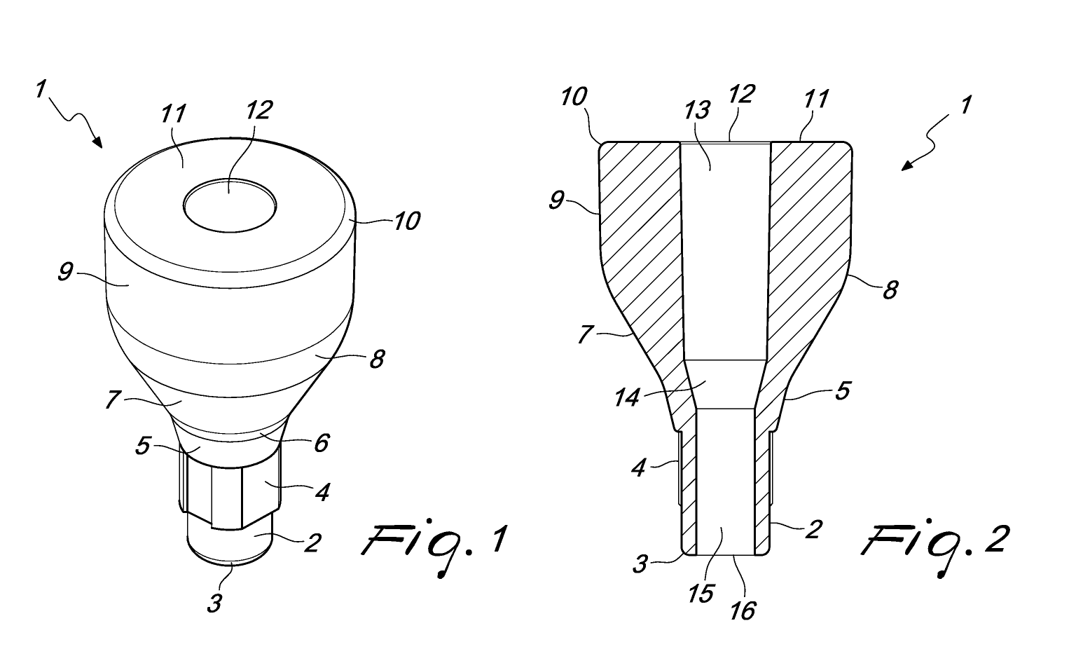

With reference to FIGS. 1 and 2, a currently preferred embodiment of the gingivaformer for a dental implant with improved coloring is described according to the present invention. The gingivaformer, which is generally indicated with the reference numeral 1, has an apically situated pin portion for rotationally secured accommodation in an implant screw, with a conical section adjoining thereto and widening in the coronal direction, and a substantially cylindrical section 9 further coronally adjoining the conical section, the gingivaformer being manufactured from a mixture of PEEK base material with a fraction of 95 to 99% by weight and at least one dye with a fraction of 1 to 5% by weight, so that the gingivaformer is flesh-colored. The formation of the gingivaformer from PEEK is particularly advantageous, since this plastics is mechanically easily adaptable/individualisable.

The gingivaformer exhibits apically a cylindrical pin 2, which engages in a corresponding opening of a dental implant (not shown), the end face of cylindrical pin 2 facing towards the dental implant being provided with an apical bevel 3. Formed coronally adjoining is a polygonal section 4, which is not rotationally symmetrical and which, during insertion into a corresponding dental implant, acts, among other, as a rotation lock. A first conical region 5 directly adjoins, in the coronal direction, the cylindrical section 9, which transitions seamlessly into a narrow transition region 6. Moreover coronally adjoining are located two further conical sections 7, 8, the second coronal region 7 extending at an angle of more than 60° to 80° to a theoretical axial axis, and the third conical region 8 being provided with a curve. The gingivaformer exhibits, further occlusively adjoining, a rotationally symmetrical, cylindrical section 9, which exhibits a further bevel 10 at its occlusive end face. The length of the cylindrical region 9 corresponds approximately to the total extent of the second and third conical regions 7, 8 in the axial direction. Through the entire length of the gingivaformer 1 a continuous axial bore extends, through which, through a coronal opening 12, a fastening means, such as a screw, can advantageously be inserted. The axial bore consists of two round-symmetrical cavities 13, 15 and a conical cavity 14 located between the coronal cavity 13 and the apical cavity 15. The inner width of the coronal cavity 13 is greater than the inner width of the apical cavity 15. The axial bore terminates apically in an apical opening 16, which is likewise suitable for feeding a fastening means through. The entire surface of the gingivaformer 1 is dyed in a flesh color, and the entire outer surface of the gingivaformer 1 is formed smoothly and can thus not give rise to injuries in the oral cavity, e.g. to the tongue.

Although the embodiment discussed here exhibits a substantially axial shape, embodiments of the gingivaformer with angled occlusive parts (not shown) can also be realized in order to achieve a correction of the dental implant axis necessary for a given insertion direction. Thus e.g. the angle for axis correction can be approximately 10° to 20°. The circumference of the cylindrical region 9 can also be varied in order to match itself to the spatial circumstances of the tooth position.

In order to be able to realize an embodiment of the gingivaformer which is as aesthetic as possible, the gingivaformer is advantageously adapted to the color of the gum. This flesh- or gum-colored gingivaformer is manufactured using a PEEK (polyetheretherketone) plastics approved for medical applications, or so-called “medical grade” PEEK (polyetheretherketone) plastics, as the base material. Luvocom PEEK Classics 7994 VP in granulate form, for example, has proved to be as advantageous in practice. However, other “medical grade” PEEK plastics with similar properties can also be used. The base material is in general provided in granulate form. The base material cited here is provided in granulate form and has a beige-greyish hue. This color is, however, not suitable for reproducing a realistic looking gum. To achieve a realistic looking effect, it is necessary to add dyes and/or pigments. These dyes are sufficiently known in various colors; they must, however, be of the “medical grade” type. The dyes titanium dioxide for the color white, iron oxide for the color brown, and “blue pigment” for the color blue have been shown to be particularly advantageous, with other similar “medical grade” dyes also being conceivable.

For simplification, a detailed description of the melting and moulding process is avoided here, and only the mixing process is described.

This mixture can advantageously be manufactured simply and without additional costs, in already existing apparatuses for manufacture of the gingivaformers, by corresponding addition of the dye quantity.

In laboratory tests it has been shown that the best possible color results for achieving a flesh color can be attained from a mixture of PEEK base material with a fraction of 95 to 99 percent by weight (% by weight) and at least one dye with a fraction of 1 to 5% by weight. This coloring thus adapts itself to the gum in what is almost a “mimicry fashion”.

Moreover, very good results can also be achieved with designs with at least two dyes, such as brown iron oxide and blue dye, or with at least three dyes, namely brown iron oxide, blue dye and white titanium oxide, which permits a particularly fine color setting.

At present, the following dyes are preferred as particularly suitable for manufacture: titanium oxide (color: white), CAS 13463-67-7; Bayferrox 120 N iron oxide (color: brown), CAS 1309-37-1; blue pigment 385 (Sheperd Color) (color: blue).

In a currently preferred embodiment, a color selection in accordance with the Lab color space with the values in the following regions is particularly suitable:

L=55-56.8, a=19.7-22.3, b=10.7-13.2,

which can be achieved with a mixture of the PEEK base material with one or more of the preceding dyes.

### REFERENCE NUMERAL LIST

1) Gingivaformer
2) Cylindrical pin
3) Apical bevel
4) Polygonal section
5) First conical region
6) Transition region
7) Second conical region
8) Third conical region
9) Cylindrical section
10) Coronal bevel
11) Coronal end face
12) Coronal opening
13) Coronal cavity
14) Conical cavity
15) Apical cavity
16) Apical opening

What is claimed is:

1. A gingivaformer for a dental implant, wherein the gingivaformer is manufactured from a mixture of PEEK base material with a fraction of 95 to 99% by weight and at least one dye with a fraction of 1 to 5% by weight, so that the gingivaformer is flesh-colored.

2. The gingivaformer according to claim 1, wherein the at least one dye is selected from a group consisting of white titanium oxide, brown iron oxide and blue “blue pigment 385”.

3. The gingivaformer according to claim 1, wherein the dye consists of a combination of white titanium oxide and brown iron oxide.

4. The gingivaformer according to claim 1, wherein the dye consists of a combination of white titanium oxide and brown iron oxide and blue “blue pigment 385”.

5. The gingivaformer according to claim 1, wherein the color setting of the mixture of PEEK base material and dye or dyes is in accordance with the Lab color standard exhibiting the values L=55-56.8, a=19.7-22.3, b=10.7-13.2.

6. The gingivaformer according to claim 1, comprising an apically situated pin portion for rotationally secured accommodation in an implant screw, with a conical section adjoining thereto and widening in the coronal direction, and a cylindrical section further coronally adjoining the conical section.

7. The gingivaformer according to claim 1, wherein the color setting of the mixture of PEEK base material and dye or dyes is in accordance with the Lab color standard exhibiting the values L=55-56.8, a=19.7-22.3, b=10.7-13.2, and wherein the gingivaformer further comprises an apically situated pin portion for rotationally secured accommodation in an implant screw, with a conical section adjoining thereto and widening in the coronal direction, and a cylindrical section further coronally adjoining the conical section.

8. The gingivaformer according to claim 1, wherein the color setting of the mixture of PEEK base material and dye or dyes is in accordance with the Lab color standard exhibiting the values L=55-56.8, a=19.7-22.3, b=10.7-13.2, and wherein
the at least one dye is selected from a group consisting of white titanium oxide, brown iron oxide and blue “blue pigment 385”.

9. The gingivaformer according to claim 1, wherein the color setting of the mixture of PEEK base material and dye or dyes is in accordance with the Lab color standard exhibiting the values L=55-56.8, a=19.7-22.3, b=10.7-13.2, and wherein
the dye consists of a combination of white titanium oxide and brown iron oxide.

10. The gingivaformer according to claim 1, wherein the color setting of the mixture of PEEK base material and dye or dyes is in accordance with the Lab color standard exhibiting the values L=55-56.8, a=19.7-22.3, b=10.7-13.2, and wherein
the dye consists of a combination of white titanium oxide and brown iron oxide and blue “blue pigment 385”.
